(19) United States
(12) Patent Application Publication
(10) Pub. No.: US 2018/0144049 A1
(43) Pub. Date: May 24, 2018

(54) KNOWLEDGE REPRESENTION EXPANSION METHOD AND APPARATUS

(71) Applicant: KOREA ADVANCED INSTITUTE OF SCIENCE AND TECHNOLOGY, Yuseong-gu Daejeon (KR)

(72) Inventors: Key-Sun Choi, Yuseong-gu Daejeon (KR); Younggyun Hahm, Yuseong-gu Daejeon (KR); Ji Woo Seo, Yuseong-gu Daejeon (KR)

(21) Appl. No.: 15/545,054

(22) PCT Filed: Jan. 20, 2016
(86) PCT No.: PCT/KR2016/000579

§ 371 Date: Nov. 20, 2017

(30) Foreign Application Priority Data
Jan. 20, 2015 (KR) 10-2015-0009518
Oct. 2, 2015 (KR) 10-2015-0139189

(51) Int. Cl. G06F 17/30; G06F 17/27

(52) U.S. Cl. CPC G06F 17/30734; G06F 17/30684; G06F 17/30864; G06F 17/2785

(57) ABSTRACT

A knowledge representation expansion apparatus includes: a predicate-argument structure analyzing unit for extracting a predicate and at least one argument from a text using a meaning representation language; an ontology unit for representing knowledge using a knowledge representation language, which is a structured format understandable by a computer, and for extracting a second predicate corresponding to a first predicate, which is extracted from the predicate-argument structure analyzing unit; and a knowledge representation unit for representing knowledge extracted from the text using the first predicate, when the similarity of the first predicate and the second predicate is equal to or less than a threshold value.

### TECHNICAL FIELD

The present invention relates to a knowledge representation expansion method and apparatus.

### BACKGROUND ART

Recently research on question answering system based on a semantic web and big data has been actively studied. The semantic web is a semantic web representing relation between information in a distributed environment such as the Internet and semanteme in ontology that a computer may process. Also, many researches on constructing a knowledge database based on ontology are conducted. However, traditionally, knowledge is written in a natural language, and in particular, it is known that much knowledge is included in unstructured data rather than structured database according to some researches. Therefore, researches for automatically generating instances of ontology schema from unstructured data including a natural language text are conducted for expanding knowledge database.

Particularly, the semantic web has to represent knowledge of web in a structured format understandable by a computer, that is, RDF (Resource Description Framework) triple, and for this, ontology is required which has property that may fully describe various properties of knowledge elements. The RDF triple which is an international standard governed by World Wide Web Consortium (W3C) is a form representing knowledge and information in three pairs of subject (resource), predicate (property), and object (literal). Here, the property corresponds to the predicate of the RDF triple and corresponds to relation between the subject and the object.

DBpedia which is the latest technology of the semantic web is an automatically structured knowledge database from Wikipedia which is encyclopedic text. The DBpedia uses DBpedia ontology originated from infobox of the Wikipedia to represent knowledge of the Wikipedia. However, although the ontology of the DBpedia may be sufficient to represent summarized knowledge of the Wikipedia, it is difficult to assure that it may represent all knowledge on the Wikipedia text. Therefore, the ontology is needed which may represent the various properties of knowledge elements on a natural language text, and based on this, a technology for expanding knowledge by automatically constructing knowledge database is needed.

### DETAILED DESCRIPTION OF THE INVENTION

### Technical Problem

The problem that the present invention solves is a knowledge representation expansion method and apparatus and relates to a method for expanding knowledge representation by using a meaning representation language when knowledge extracted from any text may not be represented in a knowledge representation language which is used in knowledge representation ontology.

### Technical Solution

According to an aspect of an example embodiment of the present invention, a knowledge representation expansion apparatus includes a predicate-argument structure analyzing unit for extracting a predicate and at least one argument from a text using a meaning representation language, an ontology unit for representing knowledge using a knowledge representation language which is a structured format understandable by a computer, and for extracting a second predicate corresponding to a first predicate extracted from the predicate-argument structure analyzing unit, and a knowledge representation unit for representing knowledge extracted from the text using the first predicate when similarity of the first predicate and the second predicate is equal to or less than a threshold value.

The knowledge representation unit may extract the second predicate related to the at least one argument from the ontology unit.

The knowledge representation unit may extract a first domain similar to a vocabulary type assigned to the at least one argument among domains of the knowledge representation language above the threshold value, extract a first range similar to a vocabulary type assigned to the at least one argument among ranges of the knowledge representation language above the threshold value, and extract a predicate related to the first domain and the first range with the second predicate.

The knowledge representation unit may generate a string in which the first predicate and information related to any argument among the at least one argument are combined, and add the string to the knowledge representation language of the ontology unit.

The knowledge representation language may be represented in an RDF (Resource Description Framework) ternary relation.

According to another aspect of an example embodiment of the present invention, a method that an apparatus expands knowledge representation includes receiving an input of text including at least one sentence, representing the text with a first predicate and at least one argument based on a meaning representation language, extracting a second predicate corresponding to the first predicate in a knowledge representation ontology, comparing similarity of the first predicate and the second predicate, and representing knowledge extracted from the text using the first predicate when the similarity is below a threshold value.

The extracting a second predicate corresponding to the first predicate may extract the second predicate corresponding to the first predicate in the knowledge representation ontology by using a vocabulary type assigned to the at least one argument.

The knowledge representation ontology may use a knowledge representation language representing knowledge in a ternary relation of subject, predicate, and object, and the extracting a second predicate corresponding to the first predicate may extract the predicate which is similar to a vocabulary type assigned to the at least one argument among the subjects of the knowledge representation language with above the threshold value and similar to a vocabulary type assigned to the at least one argument among the objects of the knowledge representation language with above the threshold value.

The representing using the first predicate may generate a string in which the first predicate and information related to any argument among the at least one argument are combined, and represent knowledge extracted from the text by using the string.

The method may further include adding the string to the knowledge representation language of the knowledge representation ontology.

According to another aspect of an example embodiment of the present invention, a method that an apparatus expands knowledge representation includes analyzing a predicate-argument structure of a text, matching the predicate-argument structure of the text in a ternary relation of a knowledge representation language, and adding a first predicate extracted from the predicate-argument structure of the text to a predicate of the knowledge representation language based on matching similarity.

The adding to a predicate of the knowledge representation language may include extracting a second predicate matched to the first predicate of the predicate-argument structure of the text in the ternary relation of the knowledge representation language, comparing similarity of the first predicate and the second predicate, and adding the first predicate to the knowledge representation language when the similarity is below a threshold value.

The method may further include representing the text in the ternary relation by using the first predicate.

The matching in a ternary relation of a knowledge representation language may match the predicate-argument structure of the text in the ternary relation based on the arguments extracted from the predicate-argument structure of the text and similarity of a domain and range of the ternary relation.

### Advantageous Effects of the Invention

According to embodiments of the present invention, knowledge representation may be expanded by using a meaning representation language when knowledge extracted from any text may not be represented in a knowledge representation language which is used in knowledge representation ontology. In other words, according to embodiments of the present invention, the problem that knowledge representation ontology does not have sufficient coverage when constructing knowledge database from web text may be solved.

According to embodiments of the present invention, the knowledge database may be quickly and easily expanded by representing knowledge included unstructured data such as a natural language based on a sentence meaning predicate-argument structure in a knowledge representation language of a format understandable by a computer.

According to embodiments of the present invention, “relation” ontology of the knowledge database may be expanded to enhance knowledge representation and to be applied to CGC (Collaboratively Generated Content)-oriented knowledge form and analysis.

### BRIEF DESCRIPTION OF THE DRAWINGS

FIG. 1 is an example of a meaning representation language, according to an embodiment of the present invention.

FIG. 2 is a block diagram of a knowledge representation expansion apparatus, according to an embodiment of the present invention.

FIG. 3 is an example drawing describing a result of analyzing a predicate-argument structure, according to an embodiment of the present invention.

FIG. 4 is an example drawing describing a ternary relation knowledge representation structure, according to an embodiment of the present invention.

FIG. 5 is a flow chart of a knowledge representation expansion method, according to an embodiment of the present invention.

FIG. 6 is a flow chart for illustrating a knowledge representation expansion method, according to an embodiment of the present invention.

FIG. 7 is a drawing describing a result of analyzing a predicate-argument structure of an example sentence, according to an embodiment of the present invention.

FIG. 8 is a drawing describing a ternary relation knowledge representation structure of an example sentence, according to an embodiment of the present invention.

### BEST MODE FOR CARRYING OUT THE INVENTION

Hereinafter, embodiments of the present invention will be described in detail with reference to the accompanying drawings. However, the present invention may be implemented in various different forms and is not limited by the embodiments. Also, parts not related to the description are deleted in the drawings in order to clearly describe the present invention and same reference on the drawings indicates the same member.

In the whole specification, when a part “includes” an element, it means it may further include another element, not excluding another element unless there is no opposite statement.

Knowledge database stores information structured with a knowledge representation language. Ontology represents knowledge in a structured format understandable by a computer. The knowledge representation language may be various, and for example, it may be RDF triple. The RDF triple is a form representing knowledge and information in a ternary relation of subject (resource), predicate (property), and object (literal). The predicate or property of the RDF triple which is a predicate indicates an entity in a subject and an entity in an object or relationship or property between values.

Since the ontology is limited to structured information, there is a limitation that it is difficult to represent knowledge extracted from unstructured knowledge source. Particularly, as a result of considering whether sufficient knowledge may be extracted from a text through coverage calculation of ontology for DBpedia which is a center of linked data, it may be known that representation is limited when extracting new knowledge from an unstructured text as knowledge source.

Hereinafter, a method for expanding knowledge representation based on a meaning representation language will be described. In other words, when knowledge extracted from a text may not be represented in the present knowledge representation language, a method for generating new ontology instance and expanding knowledge representation will be described.

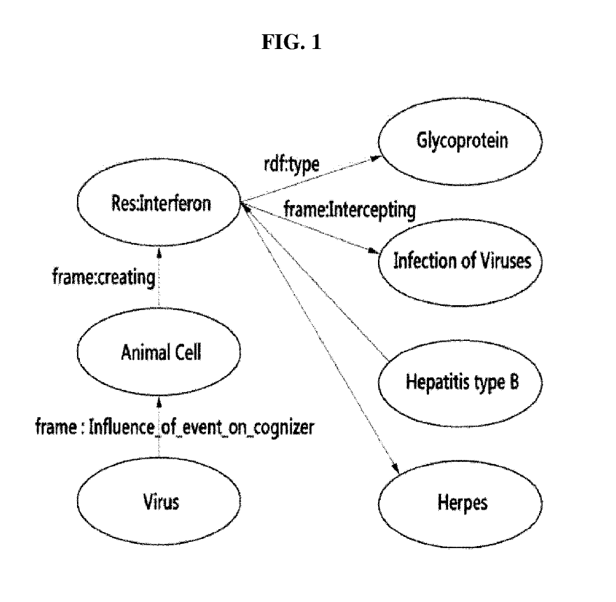

FIG. 1 is an example of a meaning representation language, according to an embodiment of the present invention.

Referring to FIG. 1, it is described with the following query sentence as an example. “It” of the query sentence is “interferon”.

Query Sentence: It is glycoprotein generated by virus-infected animal cells. It acts to prevent infection and multiplication of the virus. It is mass-produced by the development of genetic engineering and is used to treat viral diseases such as hepatitis type B or herpes.

Answer: Interferon

The ontology of the knowledge database may represent the type that it (interferon) is “glycoprotein” in structured RDF. However, in the unstructured query sentence, although the predicates such as “infected”, “generated”, “prevent”, “acts”, “mass-produced”, “is used to treat” and the like are important information, it is difficult to represent those in the knowledge representation language.

The present invention increases representation of knowledge by using a meaning representation language. Here, the meaning representation language is a language representing a meaning of sentence based on a relationship of property/predicate and argument. A predicate-argument structure represents a relationship between arguments that the predicate requires when constructing a sentence. The number of arguments is determined depending on the predicate. One predicate may require one essential argument to make clause or sentence and the other predicate may require two or three arguments.

The meaning representation language may describe cause, effect, opinion, act, statement, and the like for specific entity that is difficult to be represented in DBpedia ontology. For example, the predicate-argument structure may be extracted by using FrameNet, but it is not limited thereto. The FramNet is language source constructed by annotating how words are used in a sentence in a form of Semantic-Frame.

Referring to FIG. 1, the query sentence may be represented in a FrameNet structured graph of RDF structure. Likewise, the query sentence may be represented in the predicate-argument structure. For example, “infected” may be represented in “Influence_of_event on_cognizer” of the FramNet, “generated” may be represented in “Creating” of the FrameNet, “prevent” may be represented in “Intercepting” of the FrameNet, and “is used to treat” may be represented in “Cure” of the FrameNet.

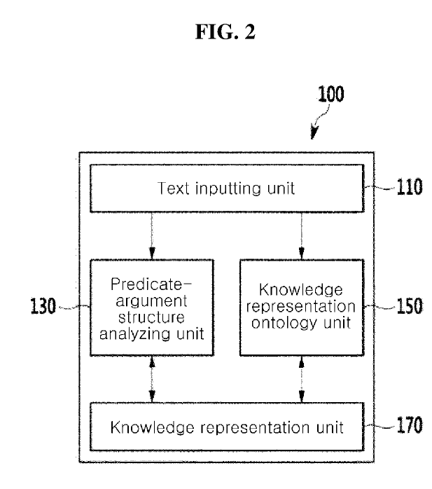

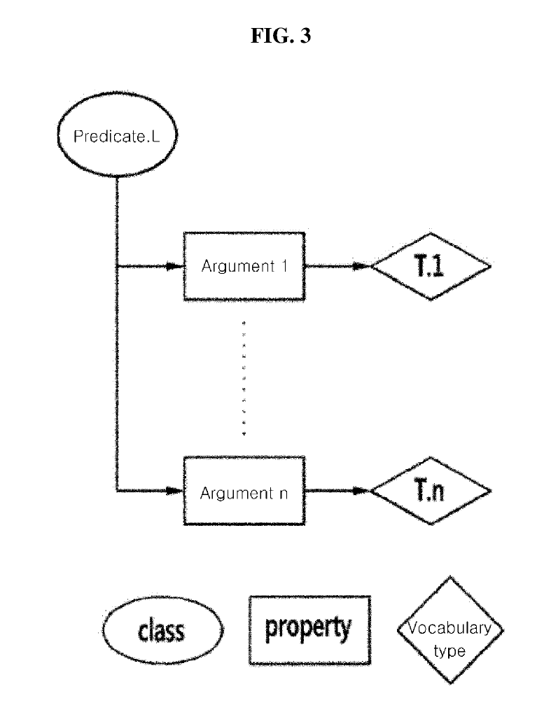

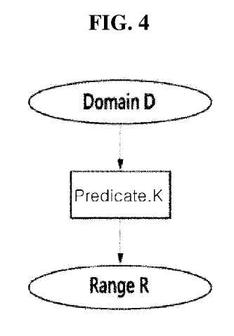

FIG. 2 is a block diagram of a knowledge representation expansion apparatus, according to an embodiment of the present invention, FIG. 3 is an example drawing describing a result of analyzing a predicate-argument structure, according to an embodiment of the present invention, and FIG. 4 is an example drawing describing a ternary relation knowledge representation structure, according to an embodiment of the present invention.

Referring to FIG. 2, a knowledge representation expansion apparatus (hereafter referred to as ‘the apparatus’) 100 includes a text inputting unit 110, a predicate-argument structure analyzing unit 130, a knowledge representation ontology unit 150, and a knowledge representing unit 170.

The text inputting unit 110 receives an input of text including at least one sentence.

The predicate-argument analyzing unit 130 divides the text with a predicate and at least one argument. A meaning representation language assigns at least one argument which must be in any word in a sentence (e.g. a word corresponding to the predicate), and represents meaning of the sentence by using the predicate-argument structure. Referring to FIG. 3, the predicate-argument analyzing unit 130 finds a predicate (Predicate.L), and finds at least one argument (Argument 1 to Argument n) corresponding to the predicate. Here, the predicate-argument analyzing unit 130 may output a vocabulary type (T.1 to T.n) of each of the arguments. For example, the meaning representation language may be FrameNet. When analyzing the predicate-argument structure by using the FrameNet, the predicate-argument structure analyzing unit 130 understands a frame target in a sentence and finds a frame element. Here, the frame target corresponds to a predicate of the sentence and the frame element corresponds to an argument. The predicate-argument structure analyzing unit 130 may output annotation text for the FrameNet analyzing result.

The knowledge representation ontology unit 150 represents knowledge in a structured format understandable by a computer. For this, the knowledge representation ontology unit 150 describes properties of knowledge elements by using the knowledge representation language. For example, the knowledge representation language may be RDF (Resource Description Framework), and knowledge is represented in RDF triple, i.e. a ternary relation <S,P,O>. The knowledge representation ontology unit 150 represents a text in a predefined ternary relation. Referring to FIG. 4, the knowledge representation language may be the RDF, and may be presented in <domain D, predicate, and range R>. Here, the domain D which is a class of Domain related to the predicate corresponds to a class of the Subject in the ternary relation. The range R which is a class of Range related to the predicate corresponds to a class of object in the ternary relation. For example, DBpedia ontology may extract <people:“Chulsu”, dbo: birthplace, place:“Korea”>and <People: “Chulsu”, dbo: birthday, time: “1944”>from the sentence “Chulsu was born in 1994 in Korea” in the knowledge representation ternary relation.

The knowledge representing unit 170 may convert the predicate-argument structure of the text to the format of the knowledge representation ontology unit 150. The knowledge representation unit 170 determines whether the knowledge analyzed in the predicate-argument analyzing unit 130 may be represented in the format of the knowledge representation ontology unit 150 by comparing similarity of knowledge representation. When the knowledge analyzed in the predicate-argument structure analyzing unit 130 may be sufficiently represented in the format of the knowledge representation ontology unit 150, the knowledge representation unit 170 extracts knowledge from the text in the format of the knowledge representation ontology unit 150. If the knowledge analyzed in the predicate-argument structure analyzing unit 130 may not be sufficiently represented in the format of the knowledge representation ontology unit 150, the knowledge representation unit 170 represents the text by using the knowledge analyzed in the predicate-argument structure analyzing unit 130. Therefore, the knowledge representation unit 170 extracts knowledge from the text based on the meaning representation language when it is difficult to properly represent meaning of the text in the predefined ternary relation. Also, the knowledge representation unit 170 may transmit the generated property (ontology instance, corresponding to the predicate) to the knowledge representation ontology unit 150 by using the meaning representation language. The knowledge representation ontology unit 150 may add the information (ontology instance) generated by using the meaning representation language to the knowledge representation language.

Likewise, the knowledge representation expansion apparatus 100 may expand the knowledge representation of the knowledge representation ontology by using the meaning representation language.

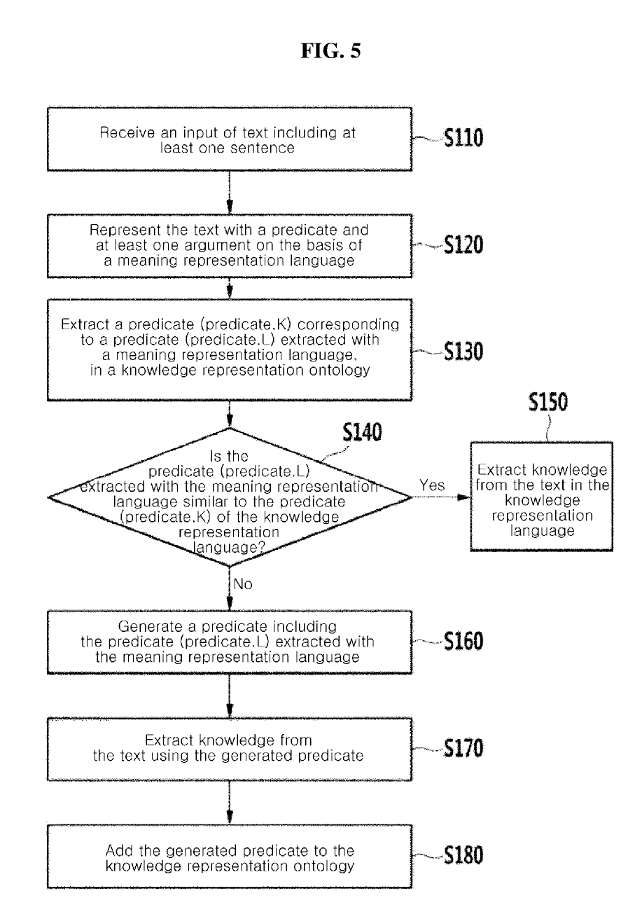

FIG. 5 is a flow chart of a knowledge representation expansion method, according to an embodiment of the present invention.

Referring to FIG. 5, the apparatus 100 receives an input of text including at least one sentence S110.

The apparatus 100 represents the text with a predicate and at least one argument on the basis of a meaning representation language S120. The apparatus finds predicate (predicate. L) and argument of the predicate (argument 1 to argument n) in the text such as FIG. 3. Here, the apparatus 100 may output a vocabulary type (T.1 to T.n) of each of the arguments.

The apparatus 100 extracts a predicate (predicate. K) corresponding to the predicate (predicate. L) S130. The apparatus 100 matches a predicate-argument structure of the text in a ternary relation of the knowledge representation language. According to a result of predicate-argument structure analysis, the apparatus 100 may extract the predicate (predicate. K) corresponding to domain D and range R as FIG. 4 when arguments corresponding to the domain D and the range R of the ternary relation knowledge representation are secured. The apparatus 100 may find the domain D and the range R which are same or similar with the vocabulary type of the argument.

The apparatus 100 determines similarity between the predicate (predicate.L) extracted with the meaning representation language and the predicate (predicate. K) of the knowledge representation language S140. Here, the apparatus 100 may determine the similarity of the predicate (predicate. L) extracted with the meaning representation language and a string combined with the vocabulary type of argument and the predicate (predicate. K) of the knowledge representation language.

As methods of determining the similarity, there are methods such as 1) similarity of string level (Edit distance) 2) similarity of word meaning (measuring the similarity utilizing concept hierarchy using language resource, 3) measuring word similarity based on corpus, and the like. To measure 1) the similarity of string level, there is a way calculating the number of editing operations that one string takes to convert to a target string, and traditionally, there is a method such as Levenshtein Distance. 2) The similarity of word meaning calculates the similarity between words by measuring distance in the hierarchy by using word database such as WordNet. Traditionally, there are methods such as a method measuring minimum distance between nodes of WordNet hierarchy such as path similarity, a method measuring minimum distance and maximum depth between nodes such as Leacock & Chodorow similarity, a method utilizing minimum distance between nodes and a distance from a minimum upper node between nodes such as Wu&Palmer similarity, and the like. In the case of 3) the measuring word similarity based on corpus, it is a method measuring similarity between words in a similar vector space by calculating each of words in corpus to have specific vector value in dimension space. Recently, an approach using word embedding is used.

In the similar case, the apparatus 100 extracts knowledge from the text by using the prestored knowledge representation language S150. Because the knowledge analyzed in the meaning representation language may be sufficiently represented in the format of the knowledge representation ontology, the apparatus 100 may represent the knowledge of the text in the format of the knowledge representation language. In other words, because the predicate (predicate. L) extracted with the meaning representation language is similar to the predicate (predicate. K) of the knowledge representation language with above a threshold value, the apparatus 100 determines that the input text may be sufficiently represented in the format of the knowledge representation language without needing to expand the knowledge representation. The knowledge may be represented in <a vocabulary corresponding to domain D, predicate. K, a vocabulary corresponding to range R>.

In the dissimilar case, the apparatus 100 generates a predicate including the predicate (predicate. L) extracted with the meaning representation language S160.

The apparatus 100 extract knowledge from the text by using the generated predicate S170. In other words, the apparatus 100 represents the input text based on the stored knowledge representation ontology if the text may be represented in the ternary relation existed in the knowledge representation ontology, and the apparatus 100 represents the input text in an expanded ternary relation by using the predicate of the predicate-argument structure if the text may not be represented in the knowledge representation ontology. The knowledge may be represented in <a vocabulary corresponding to the domain D, the predicate. L, and a vocabulary corresponding to the range R> or <a vocabulary corresponding to the domain D, a vocabulary type corresponding to the predicate. L+the range R, a vocabulary corresponding to the range R>.

The apparatus 100 adds the generated predicate to the knowledge representation ontology S180. The generated predicate is added to a new knowledge representation instance.

Next, a method extracting knowledge from an example sentence “Chulsu was born in Korea in 1944.” will be described as an example.

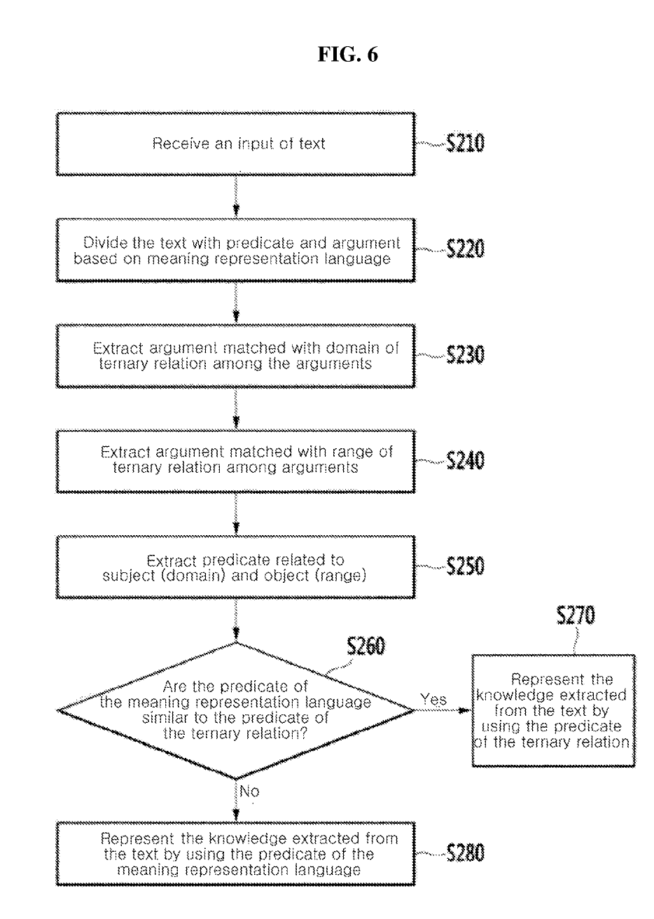

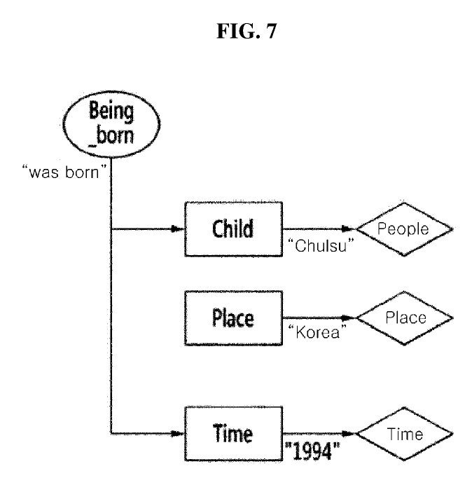

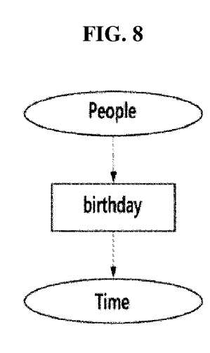

FIG. 6 is a flow chart for illustrating a knowledge representation expansion method, according to an embodiment of the present invention, FIG. 7 is a drawing describing a result of analyzing a predicate-argument structure of an example sentence, according to an embodiment of the present invention, and FIG. 8 is a drawing describing a ternary relation knowledge representation structure of an example sentence, according to an embodiment of the present invention.

Referring to FIG. 6, the apparatus 100 receives an input of text “Chulsu was born in Korea in 1922.” S210.

The apparatus 100 divides the text with a predicate and an argument based on a meaning representation language S220. When the arguments for the predicate “was born” are “who”, “when”, “where”, strings corresponding to the arguments are “Chulsu”, “Korea”, “1944”. When using FrameNet, a frame subject is “was born” and a frame predicate class is “being_born”. Because frame arguments for the frame predicate class “being_born” are fixed with “Child”, “Place”, “Time”, frame argument-string pairs are Child-Chulsu, Place-Korea, and Time-1944. Also, vocabulary types for the arguments are fixed, and a vocabulary type for “Child” may be “people”, a vocabulary type for “Place” may be “place”, and a vocabulary type for “Time” may be “time”.

The apparatus 100 extracts an argument which is matched to a domain of ternary relation among the arguments by comparing arguments and the domain of ternary relation S230. The apparatus 100 may find the domain of ternary relation which is similar to the vocabulary types of the arguments. The apparatus 100 finds domain/range related to the arguments in order to convert the predicate-argument structure to the ternary relation, and firstly may measure argument-domain similarity. The apparatus 100 may determine that “people” among the vocabulary types of the arguments is similar to “people” of the domain of ternary relation.

The apparatus 100 extracts an argument which is matched to the range of ternary relation among the arguments S240. The apparatus 100 may determine that “time” among the vocabulary types of the arguments is similar to “time” which is the range of ternary relation.

The apparatus 100 extracts a predicate related to a subject (domain) and an object (range) because the subject (domain) and the object (range) required by the ternary relation knowledge representation are extracted S250. Referring to FIG. 8, a predicate related to a domain “people” and a range “Time” is “birthday”.

The apparatus 100 measures similarity of the predicate “being_born” of the meaning representation language and the predicate “birthday” of the ternary relation S260. Here, the apparatus 100 may combine the argument related to the predicate “being_born”! the vocabulary type of the related argument/and the related range “time”, generate a combined string “being_bornTime”, and compare “being_bornTime” and “birthday”.

When the predicates are similar, the apparatus 100 represents the knowledge extracted from the text by using the predicate “birthday” of ternary relation S270. The knowledge extracted from the text may be <Chulsu, birthday, 1944> and “Chulsu” and “1944” may be linked in URI.

When the predicates are dissimilar, the apparatus 100 represents the knowledge extracted from the text by using the predicate “being_born” of the knowledge representation language S280. In other words, because the present defined predicate “birthday” may not sufficiently represent the meaning of the sentence, the apparatus 100 uses the predicate of the meaning representation language instead of the predicate of ternary relation. Here, the new generated predicate may be a string including “being_born”, and for example, it may be “being_bornTime”. The knowledge extracted from the text is represented in the expanded ternary relation, and for example, it may be <Chulsu, being_born, 1944> or <Chulsu, being_bornTime, 1944>. “Chulsu” and “1944” may be linked in URI.

The apparatus 100 stores the new predicate in the predicate related to the domain “people” and the range “Time”. Here, the new predicate is a string including “being_born”, and for example, it may be “being_bornTime”.

Although the present defined predicate “birthday” includes time information similar to “1944”, insufficient knowledge may be represented because “1944” is only the year of birth, not “birthday”. Therefore, the apparatus 100 may change the predicate to “being_born” or more specified “being_bornTime”.

Likewise, the apparatus 100 may automatically expand limited representation of the knowledge representation language by using the meaning representation language, and through this, more accurate knowledge may be constructed.

Meanwhile, the apparatus 100 may determine that “place” among the vocabulary types of the arguments is similar to “Place” which is the range of ternary relation. The predicate related to the domain “people” and the range “Place” is “birthplace”. With the same method with the above described method, the apparatus 100 may use just “birthplace” or may extract knowledge by using an expanded predicate such as “being_bornPlace” and the like.

The apparatus 100 may expand knowledge representation of knowledge database based on ontology as well as DBdepia. The apparatus 100 may be expanded to the meaning representation language which is ontologized in a format that classification for any word in a sentence is designated such as FrameNet and is designated arguments related to the word.

Likewise, according to an embodiment of the present invention, when the knowledge representation language which is used in the knowledge representation ontology may not represent knowledge extracted from any text, the knowledge representation may be expanded by using the meaning representation language. In other words, according to an embodiment of the present invention, a problem that the knowledge representation ontology does not have sufficient coverage when constructing knowledge database from web text may be solved.

According to an embodiment of the present invention, the knowledge database may be quickly and easily expanded by representing knowledge included unstructured data such as a natural language based on a sentence meaning predicate-argument structure in a knowledge representation language of a format understandable by a computer.

According to an embodiment of the present invention, “relation” ontology of the knowledge database may be expanded to enhance knowledge representation and to be applied to CGC (Collaboratively Generated Content)-oriented knowledge form and analysis.

The knowledge representation expansion apparatus 100 includes a memory storing instructions for performing the knowledge representation expansion method described referring to FIGS. 1 to 8 or loading instructions from a storing device and storing temporarily the loaded instructions, a processor processing the knowledge representation expansion method of the present invention by executing the instructions stored or loaded in the memory, and a communication device. The instructions for performing the knowledge representation expansion method described referring to FIGS. 1 to 8 are implemented with a program that the processor may process.

### DESCRIPTION OF EMBODIMENTS FOR CARRYING OUT THE INVENTION

The embodiments of the present invention described above may be implemented not only through the apparatus and the method, but also though a program executing a function corresponding to the configurations of the embodiments of the present invention or a recording medium that the program is recorded.

Although the embodiments of the present invention are described in detail above, claims of the present invention are not limited thereto, and various modifications and variations of those skilled in the art using the basic concept of the present invention defined in the following claims are included in claims of the present invention.

1. A knowledge representation expansion apparatus comprising:
a predicate-argument structure analyzing unit for extracting a predicate and at least one argument from a text using a meaning representation language;
an ontology unit for representing knowledge using a knowledge representation language which is a structured format understandable by a computer, and for extracting a second predicate corresponding to a first predicate extracted from the predicate-argument structure analyzing unit; and
a knowledge representation unit for representing knowledge extracted from the text using the first predicate when similarity of the first predicate and the second predicate is equal to or less than a threshold value.

2. The knowledge representation expansion apparatus of claim 1, wherein the knowledge representation unit extracts the second predicate related to the at least one argument from the ontology unit.

3. The knowledge representation expansion apparatus of claim 2, wherein the knowledge representation unit extracts a first domain similar to a vocabulary type assigned to the at least one argument among domains of the knowledge representation language above the threshold value, extracts a first range similar to a vocabulary type assigned to the at least one argument among ranges of the knowledge representation language above the threshold value, and extracts a predicate related to the first domain and the first range with the second predicate.

4. The knowledge representation expansion apparatus of claim 3, wherein the knowledge representation unit generates a string in which the first predicate and information related to any argument among the at least one argument are combined, and adds the string to the knowledge representation language of the ontology unit.

5. The knowledge representation expansion apparatus of claim 1, wherein the knowledge representation language is represented in an RDF (Resource Description Framework) ternary relation.

6. A method that an apparatus expands knowledge representation comprising:
receiving an input of text including at least one sentence;
representing the text with a first predicate and at least one argument based on a meaning representation language;
extracting a second predicate corresponding to the first predicate in a knowledge representation ontology;
comparing similarity of the first predicate and the second predicate, and representing knowledge extracted from the text using the first predicate when the similarity is below a threshold value.

7. The method of claim 6, wherein the extracting a second predicate corresponding to the first predicate extracts the second predicate corresponding to the first predicate in the knowledge representation ontology by using a vocabulary type assigned to the at least one argument.

8. The method of claim 6, wherein the knowledge representation ontology uses a knowledge representation language representing knowledge in a ternary relation of subject, predicate, and object, and
the extracting a second predicate corresponding to the first predicate extracts the predicate which is similar to a vocabulary type assigned to the at least one argument among the subjects of the knowledge representation language with above the threshold value and similar to a vocabulary type assigned to the at least one argument among the objects of the knowledge representation language with above the threshold value.

9. The method of claim 6, wherein the representing using the first predicate generates a string in which the first predicate and information related to any argument among the at least one argument are combined, and represents knowledge extracted from the text by using the string.

10. The method of claim 9 further comprising adding the string to the knowledge representation language of the knowledge representation ontology.

11. A method that an apparatus expands knowledge representation comprising:
analyzing a predicate-argument structure of a text,
matching the predicate-argument structure of the text in a ternary relation of a knowledge representation language, and
adding a first predicate extracted from the predicate-argument structure of the text to a predicate of the knowledge representation language based on matching similarity.

12. The method of claim 11, wherein the adding to a predicate of the knowledge representation language comprises:
extracting a second predicate matched to the first predicate of the predicate-argument structure of the text in the ternary relation of the knowledge representation language,
comparing similarity of the first predicate and the second predicate, and
adding the first predicate to the knowledge representation language when the similarity is below a threshold value.

13. The method of claim 11 further comprising representing the text in the ternary relation by using the first predicate.

14. The method of claim 11, wherein the matching in a ternary relation of a knowledge representation language matches the predicate-argument structure of the text in the ternary relation based on the arguments extracted from the predicate-argument structure of the text and similarity of a domain and a range of the ternary relation.
